(19) United States
(12) Patent Application Publication
(10) Pub. No.: US 2012/0166354 A1
(43) Pub. Date: Jun. 28, 2012

(54) CUSTOMIZED REVIEW SYSTEM AND METHOD

(75) Inventors: Judith H. Bank, Morrisville, NC (US); Lisa M. Bradley, Cary, NC (US); Lin Sun, Morrisville, NC (US); Chunhui Yang, Durham, NC (US)

(73) Assignee: INTERNATIONAL BUSINESS MACHINES CORPORATION, Armonk, NY (US)

(21) Appl. No.: 13/412,237

(22) Filed: Mar. 5, 2012

Related U.S. Application Data
(63) Continuation of application No. 12/827,657, filed on Jun. 30, 2010.

(51) Int. Cl. G06Q 30/00

(52) U.S. Cl. 705/347

(57) ABSTRACT

A method for providing a customized review may include receiving, by a processing device, a request for a customized review for a product or service from a requester. The method may also include receiving, by the processing device, a consumer profile associated with the request from the requester. The method may additionally include receiving, by the processing device, at least one review for the product or service and an associated profile for a provider of each review. The consumer profile associated with the request may be compared by the processing device to the profile associated with each review for the product or service. The method may further include providing, by the processing device, the customized review to the requester. The customized review may include any reviews by review providers with profiles that substantially match the consumer profile associated with the request.

### CROSS REFERENCE TO RELATED APPLICATION

This application is a continuation application of U.S. patent application Ser. No. 12/827,657, filed Jun. 30, 2010, the contents of which are incorporated herein by reference.

### BACKGROUND

Aspects of the present invention relate to consumer reviews of products, services or the like, and more particularly to a method, system and computer program product for providing customized reviews.

Reviews of products and services by other purchasers and/or users of the products or services are often used in making a decision about whether to purchase and use the product or service. However, such reviews can sometimes be misleading depending upon certain characteristics of the reviewer and the purchaser which can be diverse or much different. For example, when purchasing clothing, such as a pair of shoes, a review that the shoes are comfortable may be reliable but a review whether or not the shoes are stylish may not be useful or reliable because different ethnic groups, age groups or other differences in characteristics may have a different perspective on style. Similarly, a review on a restaurant, movie or other source of entertainment may or may not be pertinent depending upon the background of the person providing the review and the person trying to make a consumer decision based on the review.

### BRIEF SUMMARY

According to one aspect of the present invention, a method for providing a customized review may include receiving, by a processing device, a request for a customized review for a product or service from a requester. The method may also include receiving, by the processing device, a consumer profile associated with the request from the requester. The method may additionally include receiving, by the processing device, at least one review for the product or service and an associated profile for a provider of each review. The consumer profile associated with the request may be compared by the processing device to the profile associated with each review for the product or service. The method may further include providing, by the processing device, the customized review to the requester. The customized review may include any reviews by review providers with profiles that substantially match the consumer profile associated with the request.

According to another aspect of the present invention, a system for providing a customized review may include a processor and a module, operating on the processor, for providing the customized review for a product or service. The module may include a module to receive a request for the customized review for the product or service and a consumer profile associated with the request. The module may also include a module to receive at least one review for the product or service and an associated profile for a provider of each review. Another module may compare the consumer profile associated with the request to the profile associated with each review for the product or service and may provide the customized review to the requester. The customized review may include any reviews by review providers with profiles that substantially match the consumer profile associated with the request.

According to a further aspect of the present invention, a computer program product for providing a customized review may include a computer readable storage medium having computer readable program code embodied therewith. The computer readable program code may include computer readable program code configured to receive a request for a customized review for a product or service from a requester. The computer readable program code may also include computer readable program code configured to receive a consumer profile associated with the request from the requester. The computer readable program code may also include computer readable program code configured to receive at least one review for the product or service and an associated profile for a provider of each review. The computer readable program code may additionally include computer readable program code configured to compare the consumer profile associated with the request to the profile associated with each review for the product or service. The computer readable program code may further include computer readable program code configured to provide the customized review to the requester. The customized review may include any reviews by review providers with profiles that substantially match the consumer profile associated with the request.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of an example of a method for providing a customized review in accordance with an embodiment of the present invention.

FIG. 2 is an example of a graphical user interface (GUI) to allow configuration of a profile for requesting a customized review or that may be associated with a review by the profile owner or reviewer in accordance with an embodiment of the present invention.

FIG. 3 is a block schematic diagram of an example of a system for providing a customized review in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

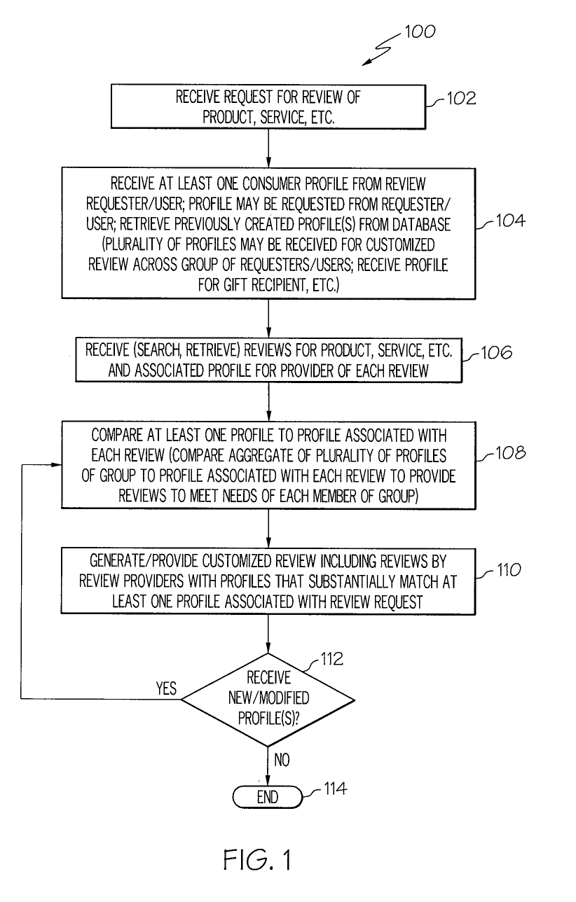

FIG. 1 is a flowchart of an example of a method 100 for providing a customized review in accordance with an embodiment of the present invention. In block 102, a request for a customize review for a product, service or the like may be received by a processing device from a review requester or user. As used herein review may also include or mean any rating of a product or service or any other type of evaluation. Accordingly, a review may include but is not limited to a written review by a consumer or user of the product or service, a number of stars or other icons representing a rating or similar indication of merit, satisfaction or other opinion or emotion relative to the product or service.

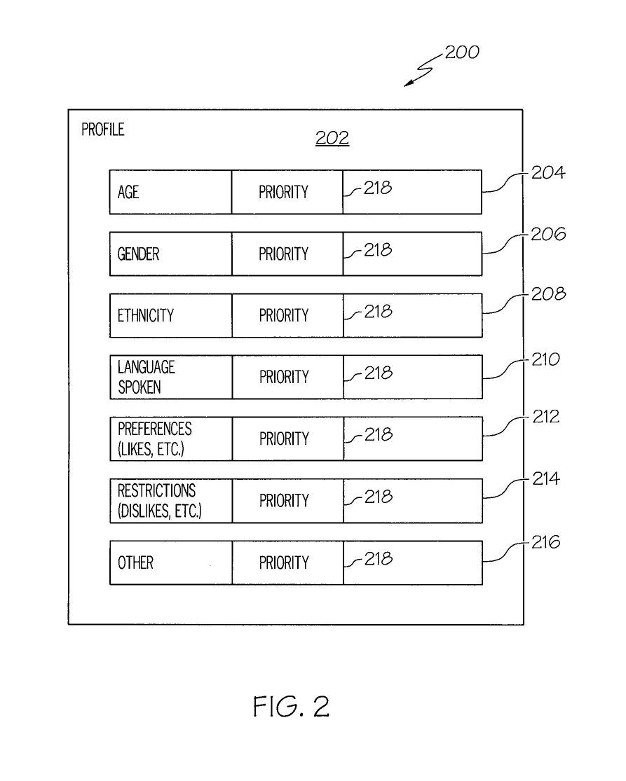

In block 104, at least one consumer profile may be received from the review requester or user. The at least one consumer profile may be requested from the requester or user or the at least one consumer profile may be retrieved from a data storage device or database if the profile was previously created and stored on the storage device or database. As described in more detail herein, a plurality of consumer profiles may be received, at least one profile for each member of a group. A customized review may then be determined and provided for the group or that substantially matches a profile of each member of the group. As described herein, certain characteristics, items or features of the profile may be emphasized or provided a selected priority or weighting in providing the customized review. The consumer profile may also correspond to or maybe for a person other than the review requester. For example, if the requester is purchasing a gift for another person, the requester may submit a profile for the intended recipient of the gift in order to obtain the customized review based on the gift recipient's profile. An example of a profile or consumer profile or graphical user interface (GUI) for configuring a profile will be described in more detail with reference to FIG. 2.

In block 106, reviews for the product or service in the review request and an associated profile for the reviewer or provider of each review may be received. A search, for example an on-line search, may be conducted to retrieve the reviews and associated profiles. The reviews may be acquired from different sources. In block 108 the at least one consumer profile associated with the review request may be compared to the profile of the reviewer or provider of each of the reviews for the product or service of interest. If a plurality of consumer profiles were received as part of the review request, an aggregate of the plurality of consumer profiles may be compared to the reviewer profile associated with each of the reviews for the product or service to provide a customized review for the group. In another aspect of the invention, each of the plurality of profiles corresponding to different members of a group may be substantially concurrently or simultaneously compared to the reviewer profile associated with each review for the product or service of interest to provide the customized review for the group.

In block 110, the customized review may be generated and provided to the requester. The customized review may include all reviews or only those reviews by review providers or reviewers with profiles that substantially match the consumer profile or profiles associated with the request.

In block 112, a determination may be made whether a new profile or profiles have been received or whether the profile or profiles previously used to generate and provide the customized review have been modified by the review requester. As described in more detail herein, the profile or profiles may be modified or changed in order to change the scope of the review search criteria or filtering criteria for generating the customized review. For example, the profile or profiles may be expanded or restricted to alter the customized review results depending upon the circumstances. If a new consumer profile or profiles have been received or the profile previously used to provide the customized review has been modified, the method 100 may return to block 108 and the method may proceed similar to that previously described to generate a customized review based on the new or modified profile or profiles. In no new or modified profile or profiles were received, the method 100 may end at termination 114.

FIG. 2 is an example of a profile or GUI 200 to allow configuration of a profile 202 for requesting a customized review or that may be associated with a review provided by the profile owner or reviewer in accordance with an embodiment of the present invention. Accordingly, the profile 202 may be a consumer profile for association with a request for a customized review or a review profile that may be associated with a review provided by the owner of the profile. The profile 202 may include a plurality of different characteristics of a consumer of a product or service or a multiplicity of different characteristics of the review provider. The characteristics may be substantially the same or may be identical to facilitate comparing the profiles. For example, the different characteristics may include but is not necessarily limited to age, gender, ethnicity, language spoken or native language, citizenship, preferences or likes, restrictions or dislikes and any other characteristics that may be helpful to a requester of a customized review to determine how useful or relevant the customized review is to the requester. Accordingly, the GUI 200 may include but is not necessarily limited to a mechanism 204 for specifying an age in the profile 202, a mechanism 206 for specifying a gender in the profile 202, a mechanism 208 for specifying an ethnicity, a mechanism 210 for specifying a language spoken, a mechanism 212 for specifying any preferences, a mechanism 214 for specifying any restrictions in the profile 202 and a mechanism 216 for specifying any other characteristics that may be helpful to the requester in obtaining a customized review that is useful or relevant to the requester based on the profile. The mechanisms 204-216 may each be dropdown list, menu, or similar arrangement for selecting or entering a specific characteristic.

A priority 218 or weighting may also be selected, entered or otherwise specified for each characteristic in generating or providing the customized review. Accordingly, an emphasis may be placed on certain characteristics in the consumer profile so that particular characteristics with a higher priority 218 or weighting may be provided a higher importance relative to characteristics with a lower priority or weighting for use in the review search criteria or filtering criteria in generating the customized review. A user or consumer may also have multiple profiles with different priority settings for different profiles depending upon the product or service for which the user or consumer may desire the customized review.

Web sites that deal with goods and services may optionally provide a user with a customizable global profile that contains preferences or characteristics, such as those described above. The profile may be enhanced and updated whenever the user enters a review or requests a customized review. The reviews may be associated with the global profile and used to enhance the user preferences reflected in the profile. Instead of producing a review system that does not take into consideration preferences of the review requester, in accordance with an aspect of the present invention, when a user views product or service reviews, the reviews may be weighted towards those reviews from other users or reviewers with matching characteristics and preferences. These features may also apply to movie reviews, concert reviews or any product or service.

Similar to that previously described, users or review requesters can also view customized or enhanced reviews for the same product with more than one profile, for example when buying gifts for others. Multiple profiles may also be used when requesting reviews for entertainment, such as movie or concert reviews. In this way reviews can be provided that may be appropriate for all viewers based on the profiles of the viewers.

The user may also use the customized review over a generalized review that may be a composite or compilation of all reviews for a product or service with search queries. For example, the user may want to see only reviews from those reviewers matching or substantially matching the user's profile and which satisfy a particular query, such as for example all products or services with a rating greater than a predetermined level.

The user may also be able to configure different profiles for different types of products or services. For example, for food, a user's profile may emphasize culture or ethnicity rather than other characteristics such as gender or age. For a toy, the profile may emphasize age and gender as opposed to other characteristics.

The user may also configure multiple profiles or multiple profiles may be submitted or received by the system. Each of the profiles may correspond to a different member of a group. The profiles may be compared simultaneously or concurrently to profiles associated with reviews to find an appropriate product or service for the group. An example of such a use may be where multiple people need to select a product or service, such that it represents the best alternative for all involved. One example may be group of people who are planning to dine together and trying to find a suitable restaurant. Each person may have cultural food preferences and restrictions (such as allergies or other restrictions) that may be important in choosing the best place to dine. These preferences and restrictions may be specified in a profile for each participant that may already exist or may be configured.

Multiple profiles may be simultaneously or concurrently used to obtain restaurant reviews that meet the specific needs of each diner based on information in his or her profile, including characteristics such as distance from home, cultural tastes, restrictions, cost, etc. Reviews from other individuals with similar profile characteristics may be compiled to determine the very best fit, and the highest reviews, while taking all profile and review input into consideration. Products (in this example restaurants) that did not meet mandatory profile requirements (such as vegetarian dishes available) may be eliminated from the reviews. If no best fit could be found, the participants or group members could have the option of iteratively widening the search (i.e. select restaurants further in distance or more expensive) or relaxing the minimum ratings or reviews considered to be acceptable. The search could be widened by modifying the profiles or by changing other parameters. Customized reviews based on the preferences of the group or changes in profile parameters could continue to be generated until a best fit is found or the search is abandoned.

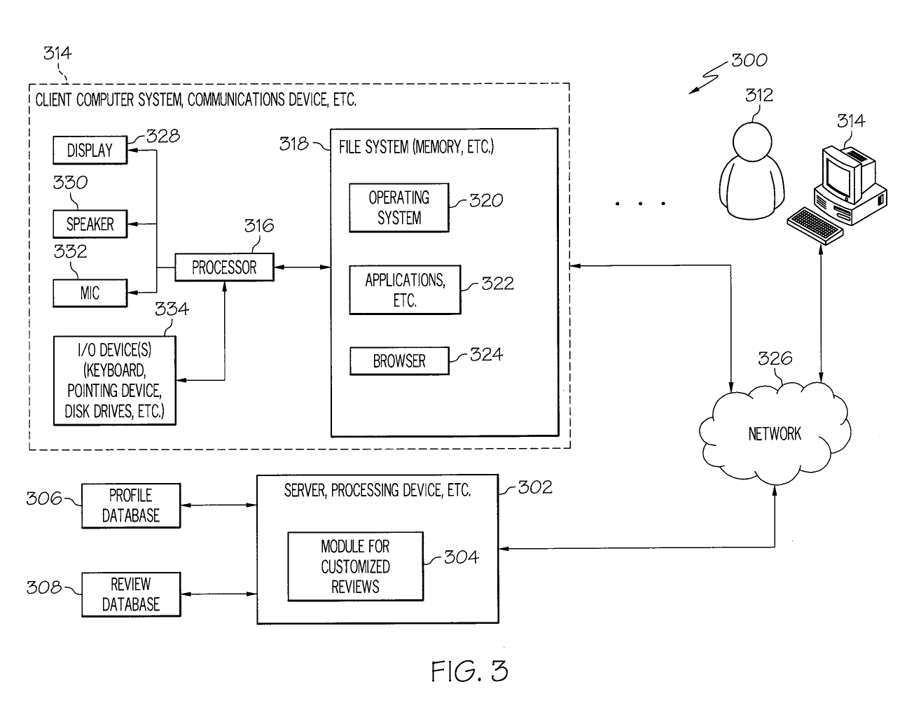

FIG. 3 is a block schematic diagram of an example of a system 300 for providing a customized review in accordance with an embodiment of the present invention. The method 100 of FIG. 1 may be embodied in or performed by the system 300. The system 300 may include a processing device 302. The processing device 302 may be a server or similar processing device. A module 304 for providing customized reviews similar to that described herein may be stored on the processing device 302 and may be operable on the processing device 302. The module 304 may be stored on a file system of the processing device 302. Portions of or all of the method 100 may be embodied in or performed by the module 304.

The system 300 may also include a profile database 306 for storing profiles. The profiles may include consumer profiles for use in generating customized reviews similar to that described herein. The profile database 306 may also include profiles of reviewers or providers of reviews for providing the customized reviews.

The system 300 may also include a review database 310 for storing reviews of products and services. A profile for the provider of each review may be associated with the respective review. Alternatively or in addition, the profiles for the reviewers may be stored in the profile database 306.

A user 312 of the system for providing customized reviews may use a computer system 314 or communications device to access the processing device 302 or server and module 304 for providing customized reviews. The computer system 314 or communications device may be any sort of communications device including a mobile or handheld computer or communications device. The computer system 314 may include a processor 316 to control operation of the computer system 314 and a file system 318, memory or similar data storage device. An operating system 320, applications 322 and other programs may be stored on the file system 318 for running or operating on the processor 316. A web or Internet browser 324 may also be stored on the file system 318 for accessing the processing device 302 or server via a network 326 for requesting a customized review. The network 326 may be the Internet, an intranet or other private or proprietary network.

The computer system 314 may also include a display 328, a speaker system 330, and a microphone 332 for voice communications. The computer system 314 may also include one or more input devices, output devices or combination input/output devices, collectively I/O devices 334. The I/O devices 334 may include a keyboard or keypad, pointing device, such as a mouse, disk drives and any other devices to permit a user, such as user 312, to interface with and control operation of the computer system 314 and to access the module 304 for requesting a customized review. The display 328 may present the customized reviews and GUIs, such as the exemplary GUI illustrated in FIG. 2 and other information related to the features described herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A method for providing a customized review, comprising:
receiving, by a processing device, a request for a customized review for a product or service from a requester;
receiving, by the processing device, a consumer profile associated with the request from the requester;
receiving, by the processing device, at least one review for the product or service and an associated profile for a provider of each review;
comparing, by the processing device, the consumer profile associated with the request to the profile associated with each review for the product or service; and
providing, by the processing device, the customized review to the requester, the customized review comprising any reviews by review providers with profiles that substantially match the consumer profile associated with the request.

2. The method of claim 1, further comprising allowing configuration of the consumer profile for submission to request the customized review, the consumer profile comprising a plurality of different characteristics of a consumer of the product or service.

3. The method of claim 2, further comprising allowing configuration of a profile for association with the review for the product or service, the profile comprising a multiplicity of different characteristics of the review provider.

4. The method of claim 3, wherein allowing configuration of the consumer profile and allowing configuration of the profile for association with the review each comprise presenting a graphical user interface and wherein presenting the graphical user interface comprises:
presenting a mechanism for specifying an age;
presenting a mechanism for specifying a gender;
presenting a mechanism for specifying any preferences; and
presenting a mechanism for specifying any restrictions.

5. The method of claim 3, further comprising allowing a priority to be assigned to each of the characteristics for use in providing the customized review.

6. The method of claim 1, further comprising allowing a consumer to configure a plurality of different profiles, wherein each profile corresponds to a different product or service.

7. The method of claim 1, further comprising allowing configuration of a plurality of profiles, wherein each of the plurality of profiles corresponds to a different member of a group, and wherein the plurality of profiles are substantially concurrently compared to the profile associated with each review for the product or service to provide the customized review for the group.

8. The method of claim 1, wherein receiving the consumer profile comprises receiving a plurality of consumer profiles, at least one profile for each member of a group and further comprising comparing an aggregate of the plurality of consumer profiles to the profile associated with each review for the product or service to provide the customized review for the group.

9. The method of claim 1, wherein receiving the consumer profile comprises receiving a consumer profile corresponding to a person other than the requester.

10. The method of claim 1, further comprising:
storing the consumer profile of a user for generating customized reviews for products and services in an online database; and
requesting the user to update the user's consumer profile in response to the user performing a transaction.

11. The method of claim 1, further comprising requesting a user to configure the profile for association with the review for the product or service in response to the user providing the review for the product or service.

12. The method of claim 1, further comprising receiving a modified consumer profile for generating a new customized review corresponding to the modified consumer profile.

13.-22. (canceled)
